(19) United States
(12) Patent Application Publication
(10) Pub. No.: US 2014/0215149 A1
(43) Pub. Date: Jul. 31, 2014

(54) FILE-SYSTEM AWARE SNAPSHOTS OF STORED DATA

(71) Applicant: LSI CORPORATION, San Jose, CA (US)

(72) Inventor: Kishore K. Sampathkumar, Bangalore (IN)

(73) Assignee: LSI CORPORATION, San Jose, CA (US)

(21) Appl. No.: 13/755,567

(22) Filed: Jan. 31, 2013

(51) Int. Cl. G06F 3/06

(52) U.S. Cl. CPC G06F 3/0689
USPC 711/114

(57) ABSTRACT

Methods and structure are provided for utilizing file-system aware backups for a Redundant Array of Independent Disks (RAID) storage system. The backup system comprises a backup storage device that includes one or more Copy-On-Write snapshots of a RAID logical volume that implements a file system. The backup system also comprises a backup controller operable to determine that a write operation is pending for an extent of the logical volume, to access allocation data for the file system to determine whether the extent was allocated to a file of the file system when a snapshot was created, and to copy the extent to the snapshot responsive to determining that the extent was allocated when the snapshot was created.

### FIELD OF THE INVENTION

The invention relates generally to storage systems, and more specifically to backup technologies for storage systems.

### BACKGROUND

Redundant Array of Independent Disks (RAID) storage systems use Copy-On-Write techniques to reduce the size of backup data for a logical volume. When Copy-On-Write is used, each snapshot of the logical volume at a point in time is initially generated as a set of pointers to blocks of data on the logical volume itself. After the snapshot is created, if a host attempts to write to the logical volume, the blocks from the logical volume that will be overwritten are first copied to the snapshot to ensure that it contains accurate data for the point in time at which it was taken. The snapshot therefore “fills in” with data that has been overwritten in the logical volume. By combining data from the Copy-On-Write snapshot and the logical volume, the storage system can change the logical volume to a state it was in at the time the snapshot was taken. However, even when Copy-On-Write techniques are employed to reduce the amount of space taken by backup data, the backup data can occupy a substantial amount of space at the storage system.

### SUMMARY

The present invention addresses the above and other problems by determining whether extents (e.g., one or more blocks of data) of a logical RAID volume are allocated within a file system at the time a snapshot of the volume is taken. If an extent of the volume is not allocated to a file when the snapshot is taken (and therefore not used by the host), the extent does not need to be copied to the snapshot when the extent is overwritten. This in turn saves space for the snapshots, because the snapshots do not store blocks of unallocated “junk” data that has been overwritten.

One exemplary embodiment is a backup system for a Redundant Array of Independent Disks (RAID) storage system. The backup system comprises a backup storage device that includes one or more Copy-On-Write snapshots of a RAID logical volume that implements a file system. The backup system also comprises a backup controller operable to determine that a write operation is pending for an extent of the logical volume, to access allocation data for the file system to determine whether the extent was allocated to a file of the file system when a snapshot was created, and to copy the extent to the snapshot responsive to determining that the extent was allocated when the snapshot was created.

Other exemplary embodiments (e.g., methods and computer readable media relating to the foregoing embodiments) may be described below.

### BRIEF DESCRIPTION OF THE FIGURES

Some embodiments of the present invention are now described, by way of example only, and with reference to the accompanying drawings. The same reference number represents the same element or the same type of element on all drawings.

FIG. 1 is a block diagram of an exemplary storage system.

FIG. 2 is a flowchart describing an exemplary method for operating a backup system to back up a logical volume.

FIGS. 3-8 are block diagrams illustrating the creation and maintenance of multiple Copy-On-Write snapshots of a logical volume in an exemplary embodiment.

FIG. 9 is a block diagram of data stored for multiple Copy-On-Write snapshots in an exemplary embodiment.

FIG. 10 illustrates an exemplary processing system operable to execute programmed instructions embodied on a computer readable medium.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

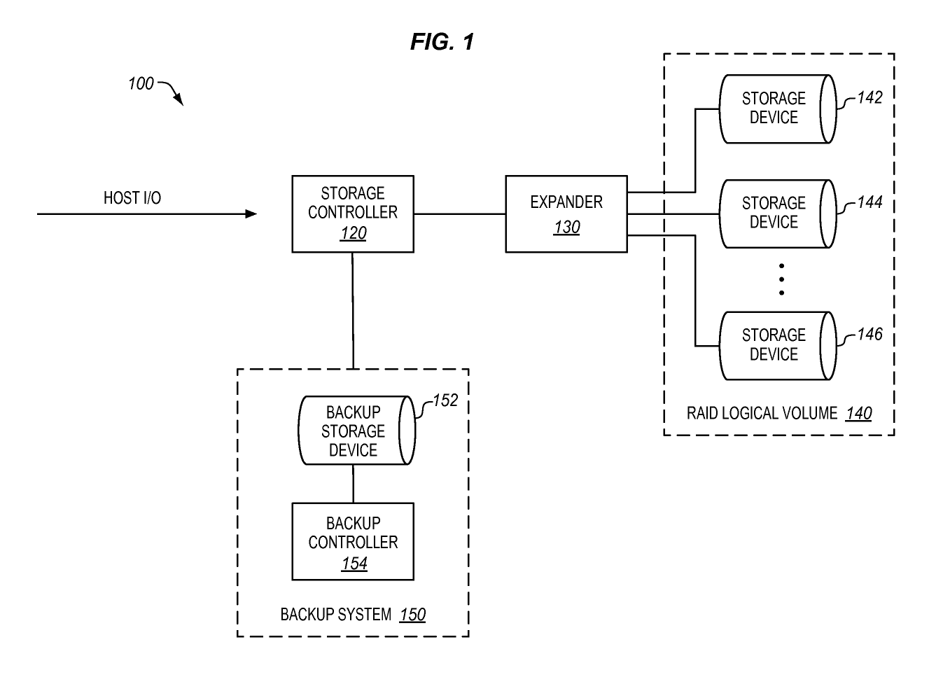

FIG. 1 is a block diagram of an exemplary Redundant Array of Independent Disks (RAID) storage system 100. Storage system 100 receives incoming Input and/or Output (I/O) operations from one or more hosts, and performs the I/O operations as requested to change or access stored digital data on one or more RAID logical volumes such as RAID volume 140 (e.g., a RAID level 0 volume, level 1 volume, level 5 volume, level 6 volume, etc.).

Storage system 100 implements enhanced backup system 150. Backup system 150 is file-system aware, which means that backup system 150 can determine which extents of a logical volume have been allocated to files of a file system. By tracking which extents of logical volume 140 are allocated when a snapshot is created, backup system 150 can ensure that Copy-On-Write is not performed on extents of “junk” data that were unallocated at the time the snapshot was taken.

In this embodiment, storage system 100 comprises storage controller 120, which manages RAID logical volume 140. As a part of this process, storage controller 120 may translate incoming I/O from a host into one or more RAID-specific I/O operations directed to storage devices 142-146. In one embodiment storage controller 120 is a Host Bus Adapter (HBA).

In this embodiment, storage controller 120 is coupled via expander 130 with storage devices 142-146, and storage devices 142-146 maintain the data for logical volume 140. Expander 130 receives I/O from storage controller 120, and routes the I/O to the appropriate storage device. Expander 130 comprises any suitable device capable of routing commands to one or more coupled storage devices. In one embodiment, expander 130 is a Serial Attached Small Computer System Interface (SAS) expander.

While only one expander is shown in FIG. 1, one of ordinary skill in the art will appreciate that any number of expanders or similar routing elements may be combined to form a switched fabric of interconnected elements between storage controller 120 and storage devices 142-146. The switched fabric itself may be implemented via SAS, FibreChannel, Ethernet, Internet Small Computer System Interface (ISCSI), etc.

Storage devices 142-146 provide the storage capacity of logical volume 140, and read or write to the data of logical volume 140 based on I/O operations received from storage controller 120. For example, storage devices 142-146 may comprise magnetic hard disks, solid state drives, optical media, etc. compliant with protocols for SAS, SATA, Fibre Channel, etc.

In this embodiment, logical volume 140 of FIG. 1 is implemented using storage devices 142-146. However, in other embodiments logical volume 140 is implemented with a different number of storage devices as a matter of design choice. Furthermore, storage devices 142-146 need not be dedicated to only one logical volume, but may also store data for a number of other logical volumes.

Backup system 150 is used in storage system 100 to store Copy-On-Write snapshots of logical volume 140. Using these snapshots, backup system 150 can change the contents of logical volume 140 to revert the contents of the volume to a prior state. In this embodiment, backup system 150 includes a backup storage device 152, as well as a backup controller 154. Backup controller 154 may be implemented, for example, as custom circuitry, as a special or general purpose processor executing programmed instructions stored in an associated program memory, or some combination thereof. In one embodiment, backup controller comprises an integrated circuit component of storage controller 120.

In some embodiments, the components of backup system 150 are integrated into expander 130. Furthermore, backup storage device 152 may be implemented, for example, as one of many backup storage devices available to backup controller 154 remotely through an expander.

The particular arrangement, number, and configuration of components described herein is exemplary and non-limiting.

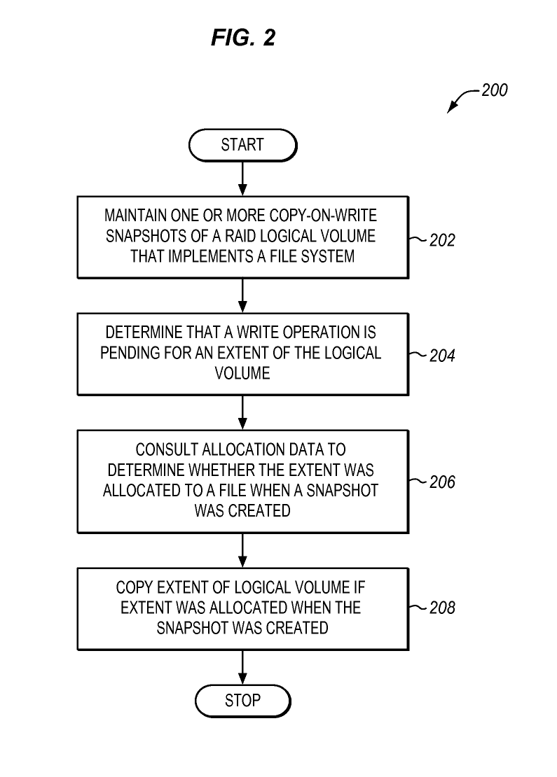

Details of the operation of backup system 150 will be described with regard to the flowchart of FIG. 2. Assume, for this operational embodiment, that RAID storage system 100 has initialized and is operating to perform host I/O operations upon the data stored in logical volume 140. Further, assume that backup controller 154 has generated multiple Copy-On-Write snapshots of the logical volume at earlier points in time, and each snapshot is stored at backup storage device 152. With this in mind, FIG. 2 is a flowchart describing an exemplary method 200 for operating a backup system to back up a logical volume.

In step 202, backup system 150 (e.g., via backup controller 154) maintains one or more Copy-On-Write snapshots of RAID logical volume 140. The snapshots are maintained on backup storage device 152. Maintaining the snapshots may include, for example, verifying the integrity of data stored on the snapshots, maintaining file allocation data for the logical volume. The allocation data indicates which blocks of logical volume 140 were allocated to files of a file system volume when each snapshot was taken. The allocation data may be stored in a central location of backup system 150, or may be stored along with each snapshot.

In step 204, backup controller 154 determines that a write operation from a host is pending for an extent of the logical volume. When a write operation is pending, a part of logical volume 140 will be overwritten with the new data. In order to maintain a consistent backup of the logical volume, controller 154 can copy the data that is about to be overwritten to a Copy-On-Write snapshot.

In step 206, backup controller 154 consults allocation data for the file system that is implemented by the logical volume, in order to determine whether any of the extents that are being overwritten by the incoming command were allocated to one or more files of a filesystem when a snapshot was created. If an extent was allocated at the time that a snapshot for logical volume 140 was created, then the extent may be copied to that snapshot in step 208. In contrast, if the extent does not include data that was allocated at the time a snapshot was taken, then the extent does not need to be copied to a snapshot. In these cases, at the time the snapshot was taken, the file system of the host did not use the data for any purpose (i.e., the data stored on the extent was just an unused collection of bits). Therefore, backing up the unallocated data to that snapshot would not serve any purpose.

As discussed above, backup controller 154 may maintain the allocation data. In one embodiment, backup controller 154 passively maintains the allocation data, and updates the allocation data by periodically reviewing a location on logical volume 140 that is known to store allocation data (e.g., file system space allocation bitmaps generated by an Operating System that implements the file system of the logical volume). For example, backup controller 154 may invoke or call an Application Programming Interface (API) of the operating system to obtain file system space allocation bitmaps (file system implementations in the Operating System provide such APIs). Backup controller 154 then creates a copy of the current file allocation data each time a new snapshot is created. The new copy of the file allocation data is associated with the newly generated snapshot for later use.

Backup controller 154 may also actively maintain the allocation data. In this embodiment, backup controller 154 maintains its own copy of the allocation data for the logical volume, and updates this copy of the allocation data each time a write is performed to the logical volume. This copy of the allocation data, maintained by backup controller 154, may then be used when generating new snapshots.

In embodiments where an extent was an allocated file for multiple snapshots, backup controller 154 may select a specific snapshot to store the data. Backup controller 154 may then update other snapshots to point towards the stored data in the selected snapshot instead of pointing at the (now altered) data in logical volume 140. Backup controller 154 may use any desirable heuristic to select a snapshot for storing the data. For example, backup controller 154 may select the oldest snapshot for which the extent was allocated, the newest snapshot for which the extent was allocated, etc.

Not every snapshot needs to be altered when an incoming write command alters an extent of the logical volume. For example, if a snapshot already stores data from the extent from an earlier point in time (or points to such data), it may not be necessary to alter that snapshot.

Even though the steps of method 200 are described with reference to storage system 100 of FIG. 1, method 200 may be performed in other systems. The steps of the flowcharts described herein are not all inclusive and may include other steps not shown. The steps described herein may also be performed in an alternative order.

### EXAMPLES

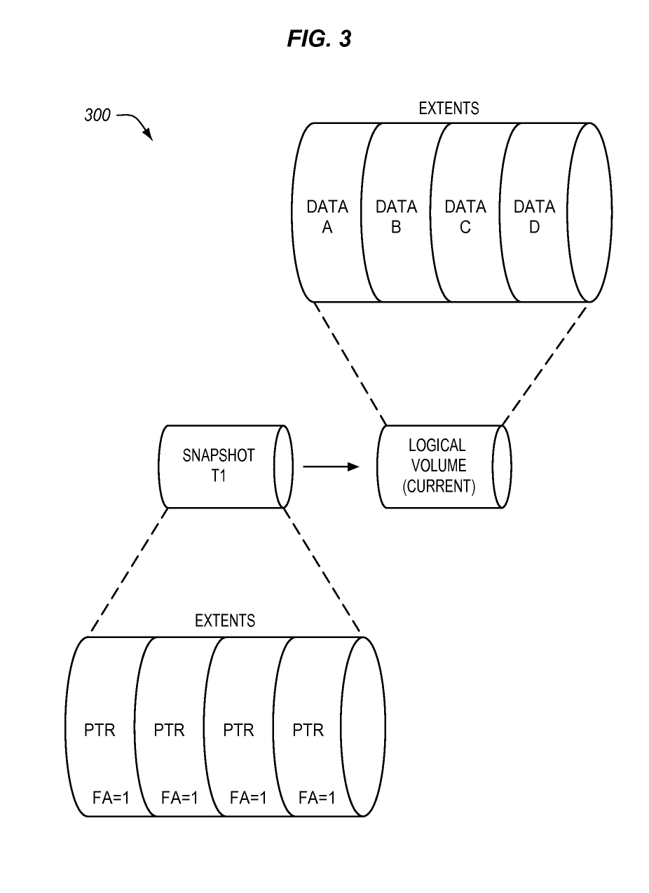

FIGS. 3-8 are block diagrams illustrating the creation and maintenance of multiple Copy-On-Write snapshots of a logical volume in an exemplary embodiment. In this embodiment, a backup system creates each snapshot at a different point in time. Thus, each snapshot can be used to re-create the logical volume as it existed at a given point in time.

FIG. 3 is a block diagram 300 illustrating the creation of a Copy-On-Write snapshot in an exemplary embodiment. In FIG. 3, a Copy-On-Write snapshot of a logical volume is created at time T1. In this simplified embodiment, the logical volume includes four extents. Snapshot T1, as created, includes four pointers. Each pointer points to a corresponding extent on the logical volume. Therefore, the leftmost pointer of snapshot T1 points to the leftmost extent of the logical volume (which stores DATA A), the rightmost pointer of snapshot T1 points to the rightmost extent of the logical volume (which stores DATA D), etc.

Snapshot T1 also includes a bit for each extent that indicates whether the extent was allocated when snapshot T1 was taken (the bit is indicated with the letters “FA”). This information can be acquired by backup controller 154 by, for example, accessing a file-system space allocation bitmap kept in the storage system (e.g., file system metadata of a Linux ext2 file system, a file allocation table of a File Allocation Table (FAT) file system, etc.). In this case, all four of the extents of the logical volume are allocated when snapshot T1 is created.

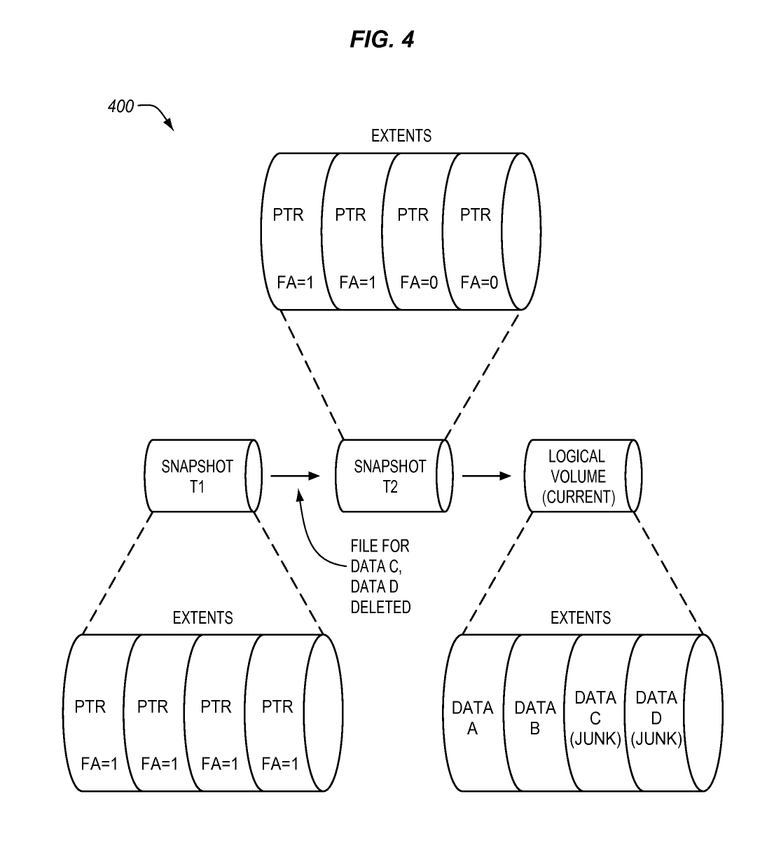

FIG. 4 is a block diagram 400 illustrating the creation of a second Copy-On-Write snapshot in an exemplary embodiment. According to diagram 400, the host deletes a file that includes DATA C and DATA D before snapshot T2 is created. In standard file systems, the act of deleting a file does not actually delete the data contained in the file. Instead, a pointer to the file or an allocation indicator for the file is removed/deleted. This means that the bits for the file data still exist physically on the volume. However, the data is “junk” because it is no longer being used by the file system and is therefore irrelevant to the host. Because DATA C and DATA D are not immediately overwritten when their corresponding file is deleted, the data from these extents is not copied to either snapshot T1 or snapshot T2.

Because snapshot T2 is created after the file for DATA C and DATA D is deleted, the File Allocation (FA) bits for the corresponding extents of snapshot T2 are set to zero.

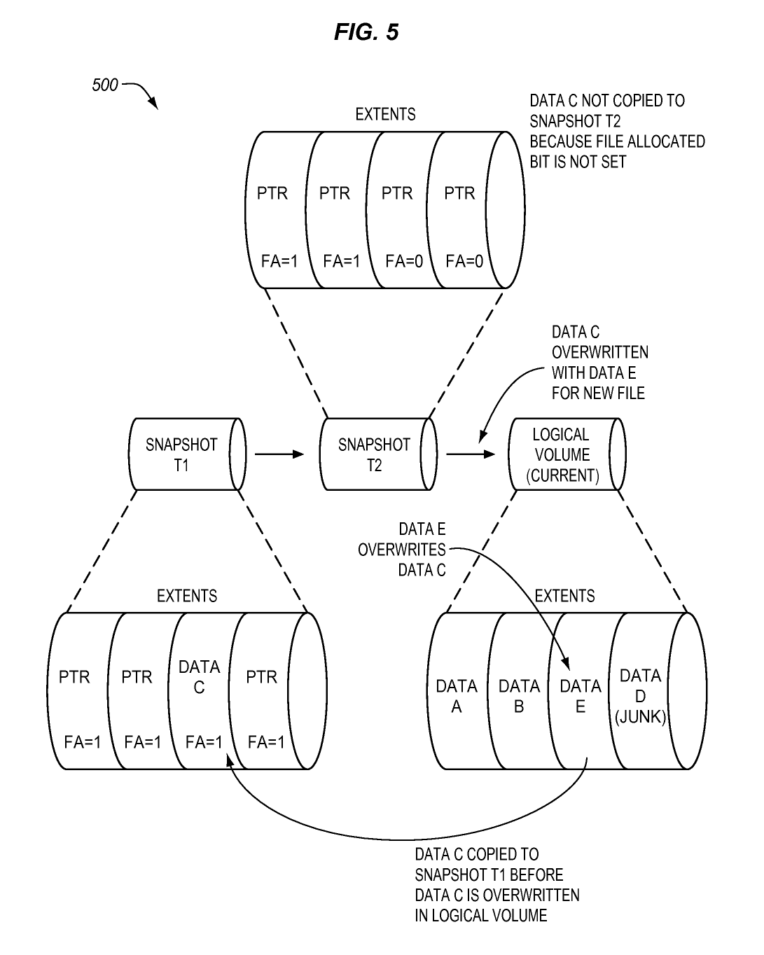

FIG. 5 is a block diagram 500 illustrating updates performed on Copy-On-Write snapshots in an exemplary embodiment. According to FIG. 5, at some point after both snapshots T1 and T2 have been created, an incoming write command attempts to overwrite DATA C with DATA E for a new file. Before the write command is executed, backup controller 154 copies DATA C to the corresponding extent of snapshot T1. However, because the extent for DATA C was not allocated when snapshot T2 was taken, snapshot T2 is not updated.

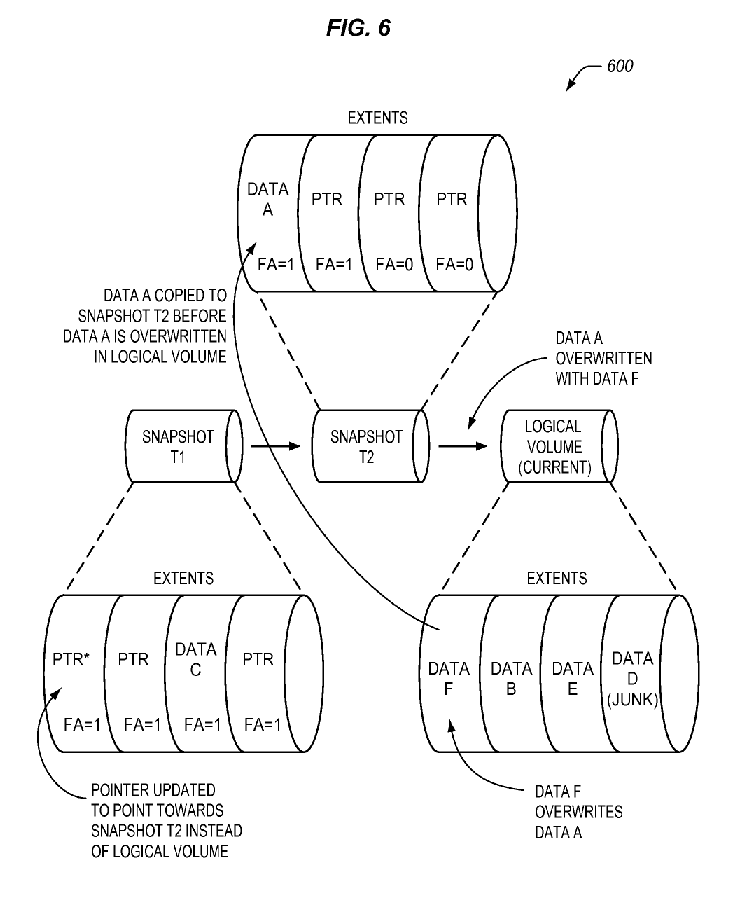

FIG. 6 is a block diagram 600 illustrating further updates performed on Copy-On-Write snapshots in an exemplary embodiment. Here, at some point after both snapshots T1 and T2 have been created, an incoming write command attempts to overwrite DATA A with DATA F. Before the write command is implemented, backup controller 154 copies DATA A to the corresponding extent of snapshot T2. Snapshot T2 is selected because snapshot T2 is the most recent snapshot created before DATA A was overwritten that also indicates that the extent for DATA A was allocated space on the file system. Backup controller 154 also updates the corresponding pointer in snapshot T1, so that it points to DATA A in snapshot T2, instead of DATA F of the logical volume as it presently exists.

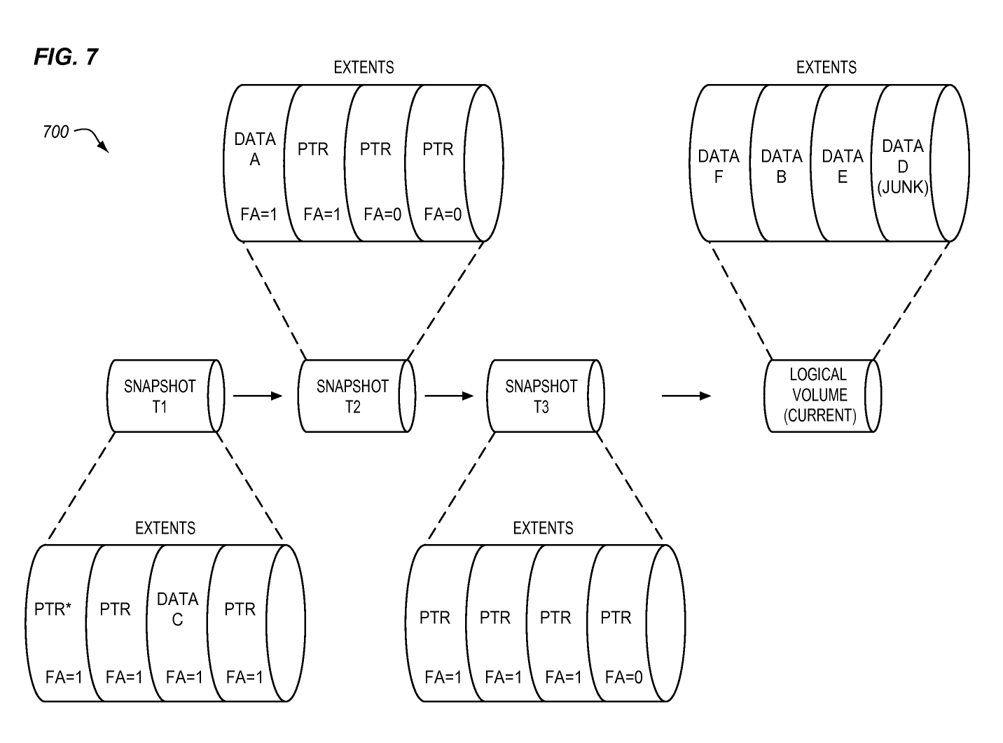

FIG. 7 is a block diagram 700 illustrating the creation of an additional Copy-On-Write snapshot in an exemplary embodiment. In FIG. 7, a third snapshot is created at time T3. When snapshot T3 is created, only the extent that includes DATA D is unallocated, so only the rightmost extent of snapshot T3 has the file allocation bit set to zero.

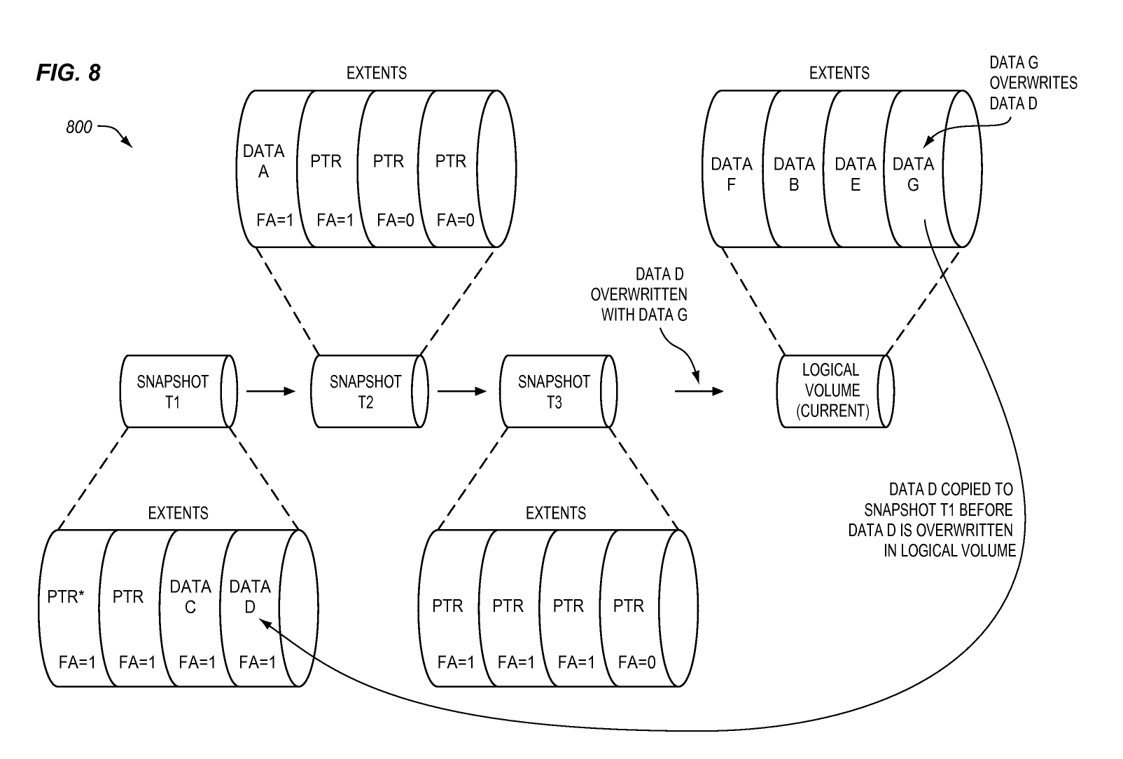

FIG. 8 is a block diagram 800 illustrating still further updates performed on Copy-On-Write snapshots in an exemplary embodiment. In FIG. 8, at some point after snapshots T1, T2, and T3 have been created, an incoming write command attempts to overwrite DATA D with DATA G. Before the write command is executed, backup controller 154 copies DATA A to the corresponding extent of snapshot T1. Snapshot T1 is selected because it is the most recent snapshot, created before DATA D was overwritten, that indicates that the extent for DATA D was allocated space on the file system at the time the snapshot was taken. Snapshots T2 and T3 consider DATA D to be “junk” data because it is currently unallocated, so the pointers for these snapshots are not updated.

Further writes to different extents may be managed in a similar manner to the steps described with regard to FIGS. 3-8. For example, if data for an extent in a logical volume is overwritten, that data may be copied to a snapshot that points to the volume for that extent, and also has the file allocation bit set for that extent.

If a snapshot is deleted, the data from that snapshot may be moved to a different snapshot, or deleted if the data is not referenced by any other snapshots. Furthermore, one or more pointers may be altered to point toward the different snapshot that now stores data that came from the deleted snapshot.

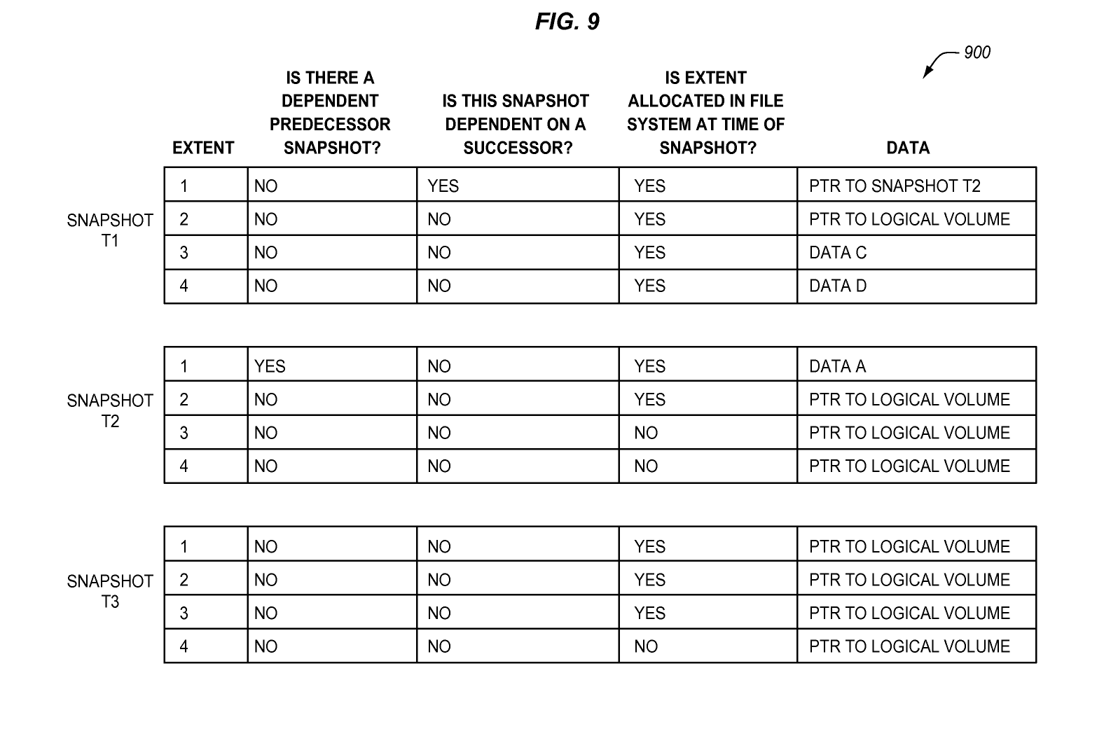

FIG. 9 is a block diagram 900 of data stored for multiple Copy-On-Write snapshots in an exemplary embodiment. FIG. 9 shows the data for each of snapshots T1, T2, and T3 after the updates and changes illustrated in FIGS. 3-8 have been performed. FIG. 9 shows various bits used to indicate different parameters for the snapshots. One bit indicates whether a previous snapshot uses data stored in the current snapshot (i.e., whether a predecessor snapshot is dependent upon this snapshot). Another bit indicates whether a later snapshot includes data needed by the current snapshot. An additional bit indicates whether a given extent was allocated at the time the snapshot was taken. Finally, a data portion of the snapshot either includes a pointer to the data that existed in a given extent at the time the snapshot was taken, or includes the actual data that was stored in the extent at the time the snapshot was taken. By using the metadata described above, backup controller 154 may efficiently move the logical volume from its current state to the state it was in at a previous time (e.g., T1, T2, or T3).

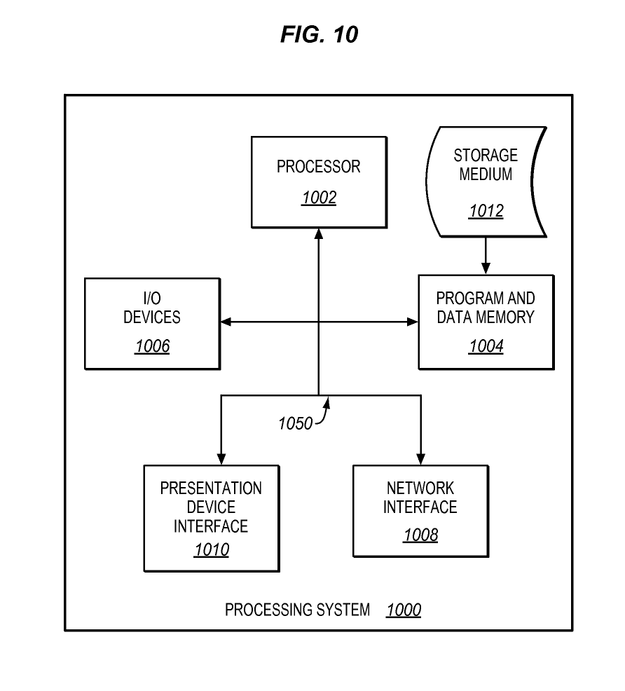

Embodiments disclosed herein can take the form of software, hardware, firmware, or various combinations thereof In one particular embodiment, software is used to direct a processing system of a backup system to perform the various operations disclosed herein. FIG. 10 illustrates an exemplary processing system 1000 operable to execute a computer readable medium embodying programmed instructions. Processing system 1000 is operable to perform the above operations by executing programmed instructions tangibly embodied on computer readable storage medium 1012. In this regard, embodiments of the invention can take the form of a computer program accessible via computer readable medium 1012 providing program code for use by a computer or any other instruction execution system. For the purposes of this description, computer readable storage medium 1012 can be anything that can contain or store the program for use by the computer.

Computer readable storage medium 1012 can be an electronic, magnetic, optical, electromagnetic, infrared, or semiconductor device. Examples of computer readable storage medium 1012 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

Processing system 1000, being suitable for storing and/or executing the program code, includes at least one processor 1002 coupled to program and data memory 1004 through a system bus 1050. Program and data memory 1004 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 1006 (including but not limited to keyboards, displays, pointing devices, etc.) can be coupled either directly or through intervening I/O controllers. Network adapter interfaces 1008 may also be integrated with the system to enable processing system 1000 to become coupled to other data processing systems or storage devices through intervening private or public networks. Modems, cable modems, IBM Channel attachments, SCSI, Fibre Channel, and Ethernet cards are just a few of the currently available types of network or host interface adapters. Presentation device interface 1010 may be integrated with the system to interface to one or more presentation devices, such as printing systems and displays for presentation of presentation data generated by processor 1002.

1. A backup system for a Redundant Array of Independent Disks (RAID) storage system, the backup system comprising:
a backup storage device that includes one or more Copy-On-Write snapshots of a RAID logical volume that implements a file system; and
a backup controller operable to determine that a write operation is pending for an extent of the logical volume, to access allocation data for the file system to determine whether the extent was allocated to a file of the file system when a snapshot was created, and to copy the extent to the snapshot responsive to determining that the extent was allocated when the snapshot was created.

2. The system of claim 1 wherein:
the backup controller is further operable to determine that the extent was allocated when multiple snapshots were created, to select one of the multiple snapshots, and to copy the extent to the selected snapshot.

3. The system of claim 1 wherein:
the backup controller is further operable to update information in other snapshots to point toward the copied extent.

4. The system of claim 1 wherein:
the file allocation data describes, for each snapshot, which extents of the snapshot corresponded to allocated files at the time the snapshot was taken.

5. The system of claim 1 wherein:
the backup controller is further operable to generate snapshots for the logical volume, and to create allocation data for generated snapshots by accessing file system space allocation bitmaps generated by an operating system that implements the file system.

6. The system of claim 1 wherein:
the backup controller is further operable to maintain allocation data for the logical volume on the backup storage device, to generate snapshots for the logical volume, and to create allocation data for generated snapshots based on the maintained file allocation data.

7. The system of claim 1 wherein:
the logical volume comprises a level 5 RAID volume.

8. A method for backing up a Redundant Array of Independent Disks (RAID) volume, comprising:
maintaining, via a backup storage device, one or more Copy-On-Write snapshots of a logical volume that implements a file system;
determining, via a processor, that a write operation is pending for an extent of the logical volume;
accessing allocation data for the file system to determine whether the extent was allocated to a file of the file system when a snapshot was created; and
copying the extent to the snapshot responsive to determining that the extent was allocated when the snapshot was created.

9. The method of claim 8 further comprising:
determining that the extent was allocated when multiple snapshots were created;
selecting one of the multiple snapshots; and
copying the extent to the selected snapshot.

10. The method of claim 8 further comprising:
updating information in other snapshots to point toward the copied extent.

11. The method of claim 8 wherein:
the file allocation data describes, for each snapshot, which extents of the snapshot corresponded to allocated files at the time the snapshot was taken.

12. The method of claim 8 further comprising:
generating snapshots for the logical volume; and
creating allocation data for generated snapshots by accessing file system space allocation bitmaps generated by an operating system that implements the file system.

13. The method of claim 8 further comprising:
maintaining allocation data for the logical volume on the backup storage device;
generating snapshots for the logical volume; and
creating allocation data for generated snapshots based on the maintained file allocation data.

14. The method of claim 8 wherein:
the logical volume comprises a level 5 RAID volume.

15. A non-transitory computer readable medium embodying programmed instructions which, when executed by a processor, are operable for performing a method for backing up a Redundant Array of Independent Disks (RAID) volume, the method comprising:
maintaining, via a backup storage device, one or more Copy-On-Write snapshots of a logical volume that implements a file system;
determining, via a processor, that a write operation is pending for an extent of the logical volume;
accessing allocation data for the file system to determine whether the extent was allocated to a file of the file system when a snapshot was created; and
copying the extent to the snapshot responsive to determining that the extent was allocated when the snapshot was created.

16. The medium of claim 15 wherein the method further comprises:
determining that the extent was allocated when multiple snapshots were created;
selecting one of the multiple snapshots; and
copying the extent to the selected snapshot.

17. The medium of claim 15 wherein the method further comprises:
updating information in other snapshots to point toward the copied extent.

18. The medium of claim 15 wherein:
the file allocation data describes, for each snapshot, which extents of the snapshot corresponded to allocated files at the time the snapshot was taken.

19. The medium of claim 15 wherein the method further comprises:
generating snapshots for the logical volume; and
creating allocation data for generated snapshots by accessing file system space allocation bitmaps generated by an operating system that implements the file system.

20. The medium of claim 15 wherein the method further comprises:
maintaining allocation data for the logical volume on the backup storage device;
generating snapshots for the logical volume; and
creating allocation data for generated snapshots based on the maintained file allocation data.
